(19) United States
(12) Patent Application Publication
(10) Pub. No.: US 2013/0193872 A1
(43) Pub. Date: Aug. 1, 2013

(54) Multi-Functional Decorative Lighting

(71) Applicants: Amanda Cousin, Kenner, LA (US); Michael Cousin, Kenner, LA (US); Chan Yet Wong, Metairie, LA (US); Cat Wong, Metairie, LA (US); Jason Reasor, New Orleans, LA (US)

(72) Inventors: Amanda Cousin, Kenner, LA (US); Michael Cousin, Kenner, LA (US); Chan Yet Wong, Metairie, LA (US); Cat Wong, Metairie, LA (US); Jason Reasor, New Orleans, LA (US)

(21) Appl. No.: 13/686,270

(22) Filed: Nov. 27, 2012

Related U.S. Application Data
(60) Provisional application No. 61/653,879, filed on May 31, 2012.
(60) Provisional application No. 61/592,144, filed on Jan. 30, 2012.

(51) Int. Cl. H05B 37/02

(52) U.S. Cl. CPC H05B 37/02
USPC 315/294

(57) ABSTRACT

A decorative lighting system designed for both residential and commercial use is provided, which offers homeowners and business owners a means by which to selectively decorate their homes and businesses in a year-round fashion. Users can install the decorative lighting either a single time or few times, and thereafter manipulate a plurality of predetermined color schemes using a pre-programmed control panel. A plurality of methods and means for controlling the programming are also disclosed.

### FIELD OF THE INVENTION

The present invention relates generally to decorative lighting, and in a particular though non-limiting embodiment, to a decorative lighting system that can be programmed by a user to emit different colors and patterns, and can remain attached to the user's home, business, recreational vehicle, automobile, etc., year-round.

### BACKGROUND

Many homeowners and business owners choose to attach decorative lighting to their homes/businesses at certain times of the year, particularly at holiday times, such as Christmas, Halloween, and the Fourth of July. However, the process can be very cumbersome, as the owner must attach and detach the lights before and after each desired holiday or celebration. Furthermore, conventional decorative lighting is typically fixed in terms of color and pattern. For example, light strands may be bought in a single color, such as all white or all blue, or in multi-colors on the same strand, alternating in color. Therefore, separate strands must be bought for each desired color or pattern, which can become very expensive.

Programmable decorative lighting is known in the art. In one prior art example, for example, a plurality of predetermined color schemes can be programmed to emphasize color schemes associated with various holidays. In that system, each bulb coordinates to a specific color. If the user does not wish to use that color, then the bulb related to that color will not be lit. The system is inefficient, however, in that it is limited to only a single such programming, and additional holiday-colored themes would require a separate, redesigned programming. Accordingly, the consumer must remove and reprogram the set in order to change theme.

There is, therefore, a long-standing, but unmet need for a decorative lighting product that overcomes deficiencies in the prior art and provides for an economical and less-time consuming way to decorate a home, business, etc., for various seasons, holidays, and other occasions.

### SUMMARY OF THE INVENTION

A decorative lighting system is provided, the system including a means for users to install said system on a facility, and thereafter control operation of said system using a pre-programmed control panel. In various embodiments the control panel admits to the programming of either (or both) a plurality of predetermined color schemes or a plurality of customized color schemes. In other embodiments the system includes a plurality of light-emitting diodes that emit a plurality of different colors, for example, three or more discrete colors. In other embodiments the system is customizable to a color or repetition scheme programmed by a user. In still other embodiments the system includes means for color mixing so that a plurality of mixed color hues are created. In further embodiments the system includes means for control amplitude modulation and/or frequency modulation.

In some embodiments, the system includes one or more conductors for controlling data transmission and color information. In others, each color group has a common lead associated therewith, and a return lead common to all such color groups. In still others, color data is embedded in wave forms rather than transmitted electronically over data lines. In further embodiments the system includes passive circuit elements so that individual nodes retain persistent color information. In others, the plurality of nodes include discrete integrated circuits.

In some embodiments the nodes are addressed using an absolute reference scheme so that nodes are addressed either individually or in series, while in other embodiments the nodes are addressed using a relative reference scheme so that nodes are addressed using a shift register. In one embodiment the control panel is configurable using one or more of a USB port, a web based interface, a personal computer, and a personal digital assistant. And in still further embodiments a wireless interface used to control either (or both) a plurality of nodes or a plurality of control panels in series.

### BRIEF DESCRIPTION OF THE DRAWINGS

FIG. 1 is a diagrammatic representation of a first embodiment of the invention.

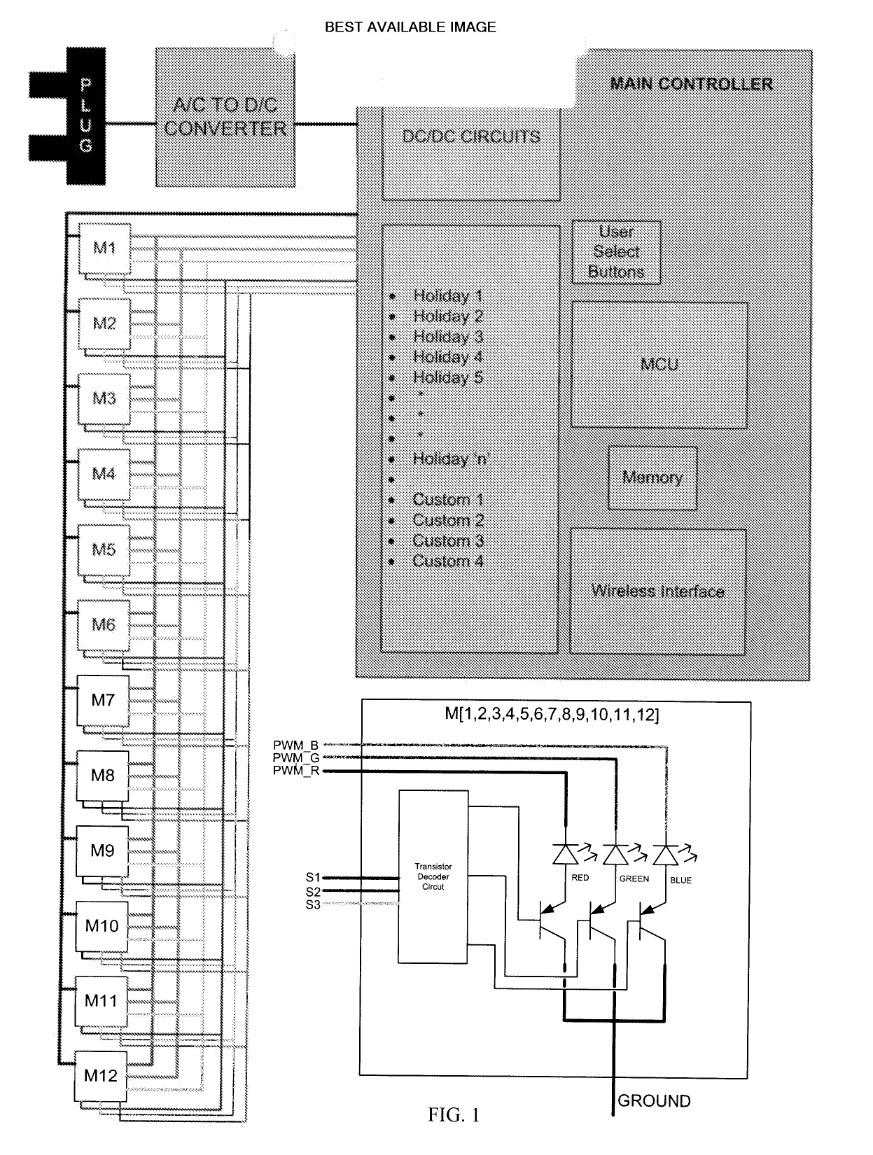

FIG. 2 is a diagrammatic representation of a second embodiment of the invention.

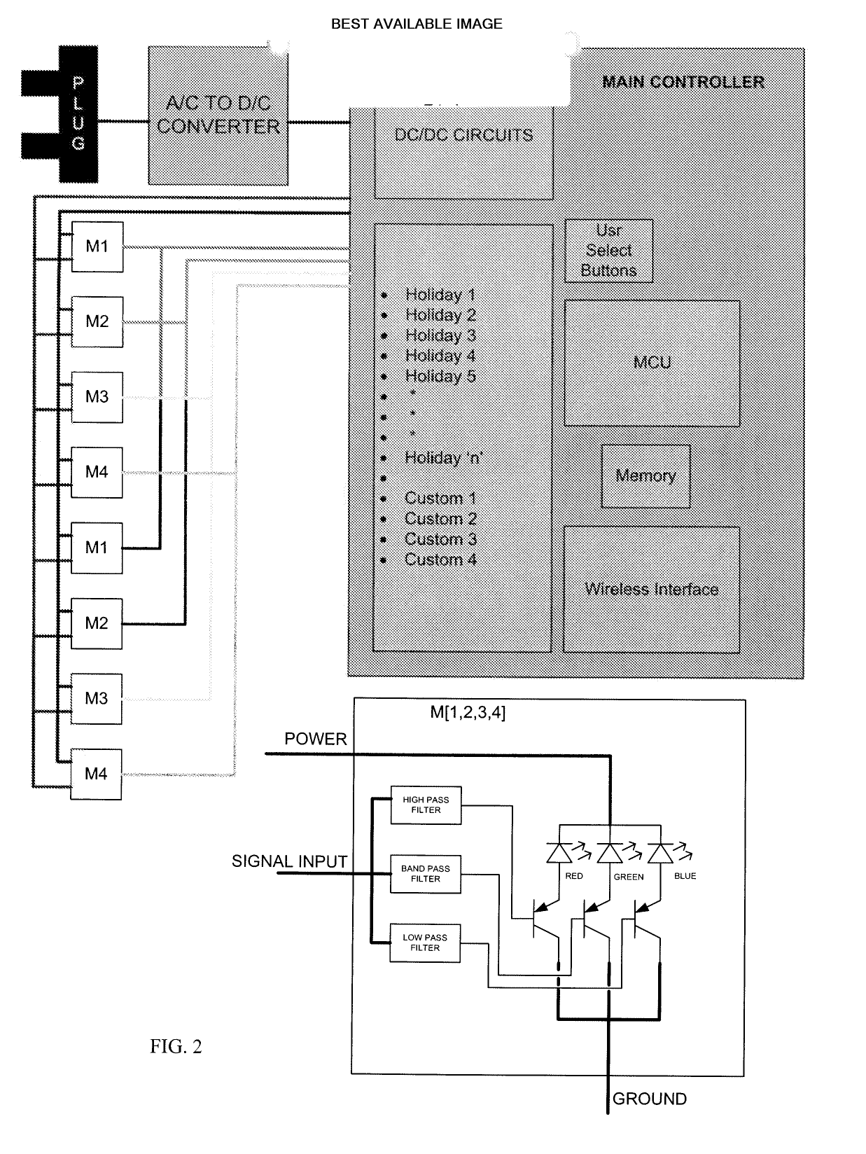

FIG. 3 is a diagrammatic representation of a third embodiment of the invention.

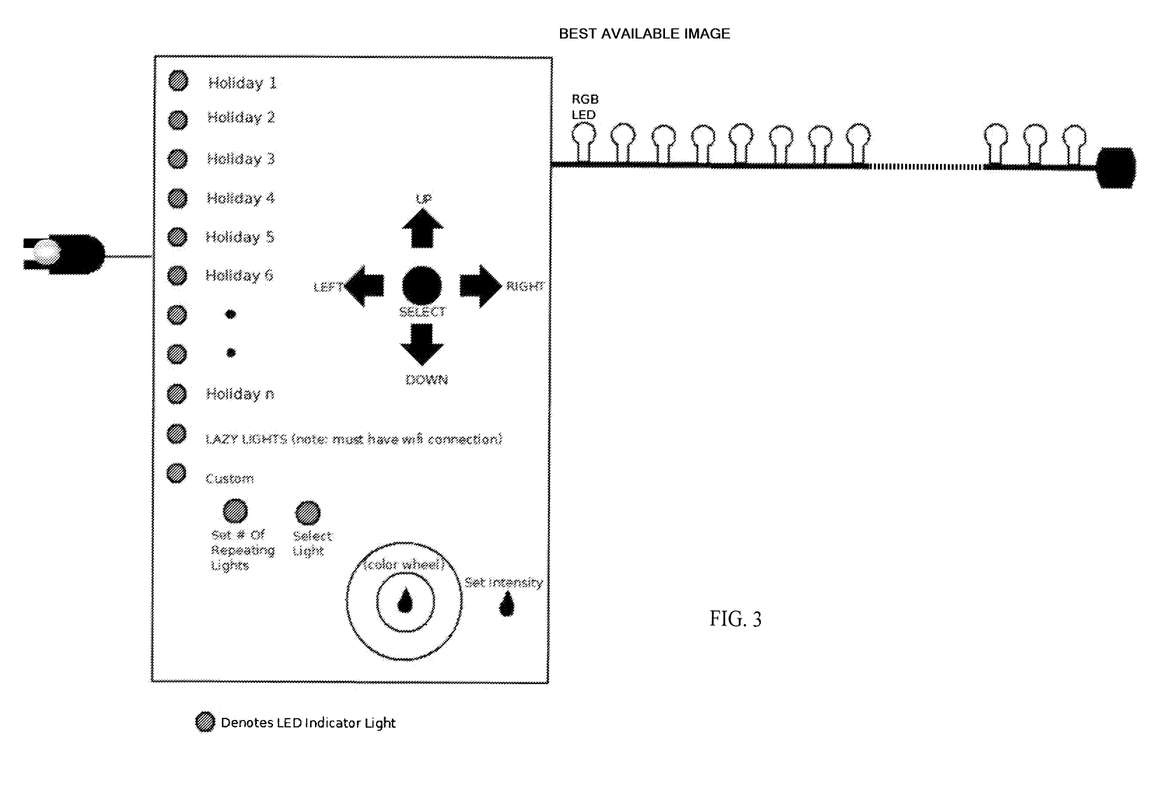

FIG. 4 is a diagrammatic representation of a fourth embodiment of the invention.

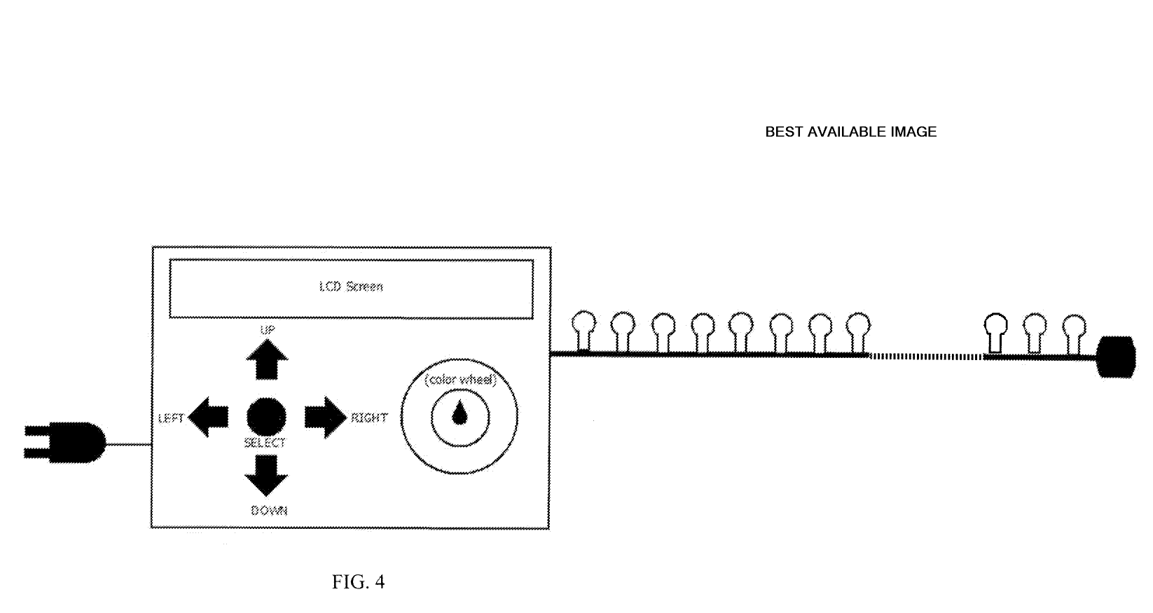

### DETAILED DESCRIPTION OF SEVERAL EXAMPLE EMBODIMENTS

In a presently preferred embodiment, a decorative lighting system designed for both residential and commercial use is provided that offers homeowners and business owners a means by which to selectively decorate their homes and businesses in a year-round fashion. Unlike the prior art, it will no longer be necessary for consumers to set up and take down light decorations for each holiday.

Instead, according to the present invention, users install the decorative lighting up a single time, and thereafter manipulate the color combinations from a pre-programmed control panel. In still other embodiments, homeowners and business owner have the capability to customize color combinations of their choice utilizing the same control panel.

In one embodiment, the decorative lighting comprises light-emitting diode (“LED”) nodes. In other embodiments, each module has its own LED. In still other embodiments, each node or module can emit a plurality, for example, three or more colors—such as red, green and blue (“RGB”). Unlike the prior art, each node has the ability to change node or module colors within the lighting scheme, meaning that potentially, no lights (or as few lights as dictated by design choice) will be “inactive” at any given time. In an example embodiment, the lighting is customizable to any color or a repeating pattern, e.g., 1-2-3-4, programmed by the user.

In further embodiments, the lighting allows for color mixing to create specific hues of color, thereby allowing for an infinite number of color creations. In some embodiments, the lighting uses amplitude modulation, so that the bulbs are always on. In this embodiment, the frequency of the carrier signal is held constant while the amplitude of the combined waves is varied to mix colors and allow for greater light intensity control. In other embodiments, the lighting uses frequency modulation to similar effect by holding the amplitude of the carrier signal constant and then modulating the frequency in order to control light intensity. Nowhere is this latter approach known in the prior art.

In other embodiments, a single conductor with data transmission and power capabilities is used, and all color information is contained in a single conductor. In further embodiments, each color has its own lead associated with it, with a return lead common to all three colors. In still other embodiments, multiple sets of data are embedded in one wave form, instead of transmitting data over multiple lines.

In further example embodiments, the lighting uses passive circuit elements, meaning that the module has persistent color information. This approach simplifies the programming process, which in turn provides a more affordable product to the consumer.

In other embodiments, the lighting uses discrete integrated circuits on each LED node. In various embodiments, the nodes are individually addressed (absolute reference) or chained together in series, or addressed using a shift register (relative reference). In these embodiments, the patterns generated by each strand can be variably changed in accord with user preferences.

In further embodiments, the nodes are packaged in an injection-molded plastic housing (or any other industry standard manufacturing techniques) that allows for quick replacement and color distinction for different applications. In other embodiments, the casing lends an aesthetic value to the overall look and feel of the light strand. In still further embodiments, the housing for each node is attached to the light's wire strand in varying physical or aesthetic configurations, such as a straight continuous light scheme, a series of icicle lights, etc.

In some embodiments, the wire used to connect the separate LEDs can comprise either multiple strands in different configurations or structured cabling which has multiple wires enclosed in a single casing.

According to other embodiments, the LED strand consists of a pre-selected number of lights based on user preference and power consumption. At both ends of the strand, there are injection molded receptacles that can be attached to either another similar strand of lights, the control panel, or terminated. These receptacles have a fixed number of leads depending on the configuration of the LEDs.

In still other embodiments, a terminator cap is used at the end of a strand or multiple strands so that the exposed leads are properly insulated.

In further example embodiments, the control panel houses some or all of the logic and power supply functions of the decorative lighting. In certain embodiments, the panel is universally configured, while in other embodiments, the panel is configured specific to the implemented application. In various embodiments, the display is either LED or LCD, with supplemental icons and/or text used to achieve fast and easy selection of the colors and patterns of the decorative lighting. In certain embodiments, the panel is configurable through either a USB port or a web based interface. In these embodiments, color information can be downloaded to the panel via personal computer, smart phone, etc.

In other embodiments, users manipulate the custom color selection via a series of knobs or other control means to select color and buttons, and/or to advance or go back in the sequence. The color selection of a custom preset pattern can be represented with RGB LEDs or the like disposed in communication with the control panel.

In still further embodiments, the control panel houses an LCD screen or the like to allow users to program their own preset patterns. Custom color presets can also be set by downloading them to the control panel either through a USB port, web based interface, or other control means. For example, color information can also be downloaded to the panel via personal computer, smart phone etc.

In some embodiments, the power supply has fixed specifications, while in other embodiments the power supply has variable specifications determined by the implementation of the decorative lighting. Power consumption may vary depending on the number of strands and physical configuration of the specific implementation being utilized. In other example embodiments, the power supply also feeds power to the logic board and other components housed within the control panel itself.

In some embodiments, the logic board contains all or some of the necessary hardware required to allow a user to select and display any number (or a predetermined number) of configurations of colors and patterns to be displayed. In further embodiments, the user selects a default control means to automatically change light colors based on the date and an associated look-up table of corresponding holidays.

In certain embodiments, the logic board contains pre-programmed light sequences and user-developed colors and patterns. Furthermore, the logic board controls the power supply so as to guarantee that the power fed to the lights themselves is adequate to meet the demands of the selected configurations and displays. In still further embodiments, the logic board houses a wireless transmitter to be used with a separate, wireless controller, thereby allowing a user freedom to control the decorative lighting from a specified range of distance from the control panel.

In other embodiments, an optional controller houses a wireless remote interface to the control panel, which allows some or all of the same selection of colors and patterns that the wired control panel allows. An LED or LCD display with supplemental icons and/or text allows the user to easily select the colors and patterns desired. Typically, batteries or wired power will be used to power the controller, though other so-called green sources of power could also be used within the scope of the disclosure. In certain embodiments, the logic board and the wireless controller only communicate commands to the control panel, and therefore do not directly control the LEDs themselves.

In certain embodiments, an optional wireless interface is used to connect multiple nodes, strands, and other control panels in series. This master/slave configuration can be used on one house or business to reduce the complexity of synchronizing multiple strands or across many houses or buildings, or to synchronize all the lights in a neighborhood of business district.

In some embodiments, the control panel updates the color information of the lights based upon real time events such as the stroke of midnight on New Year's Day or a local sports team scoring a goal. For example, the control panel can be placed in a rapid update mode where the color information is constantly updated via the Internet through a predetermined server address.

Various other embodiments utilize an optimized hardware system that reduces the number of micro-controllers to its most basic level, while still offering a maximized selection and differentiability of light selections and minimizing associated expense.

In this manner, homeowners and business owners will save both time and money, since there will no longer be a need to purchase additional, holiday-specific light sets. Furthermore, the homeowners/business owners save money due to the fact that the lighting is modular, in that the RGB LED can be removed individually in case of failure, upgrade, configuration, etc.

Furthermore, utilizing an LED light instead of a filament light also increases money saving potential since LED lights have a significantly longer working life. The system further saves time in that it does not have to be installed and then uninstalled on an annual or per holiday basis.

The foregoing specification is provided only for illustrative purposes, and is not intended to describe all possible aspects of the present invention. While the invention has herein been shown and described in detail with respect to several exemplary embodiments, those of ordinary skill in the art will appreciate that minor changes to the description, and various other modifications, omissions and additions may also be made without departing from the spirit or scope thereof.

1. A decorative lighting system, said system comprising:
means for users to install said system on a facility, and thereafter control operation of said system using a pre-programmed control panel.

2. The decorative lighting system of claim 1, wherein said control panel admits to programming of a plurality of predetermined color schemes.

3. The decorative lighting system of claim 1, wherein said control panel admits to programming of a plurality of customized color schemes.

4. The decorative lighting schemes of claim 1, wherein said system further comprises a plurality of light-emitting diode nodes.

5. The decorative lighting system of claim 4, wherein one or more of said plurality of nodes emit a plurality of different colors.

6. The decorative lighting system of claim 5, wherein said one or more of said plurality of nodes emit three or more different colors.

7. The decorative lighting system of claim 1, wherein said system is customizable to a color or repetition scheme programmed by a user.

8. The decorative lighting system of claim 1, wherein said control panel further comprises means for color mixing so that a plurality of mixed color hues are created.

9. The decorative lighting system of claim 1, wherein said control panel is used to control amplitude modulation.

10. The decorative lighting system of claim 1, wherein said control panel is used to control frequency modulation.

11. The decorative lighting system of claim 1, wherein said system further comprises one or more conductors for controlling data transmission and color information.

12. The decorative lighting system of claim 2, wherein each color group has a common lead associated therewith, and a return lead common to all such color groups.

13. The decorative lighting system of claim 2, wherein color data is embedded in wave forms rather than transmitted electronically over data lines.

14. The decorative lighting system of claim 4, wherein said system further comprises passive circuit elements so that individual nodes retain persistent color information.

15. The decorative lighting system of claim 4, wherein said nodes further comprise discrete integrated circuits.

16. The decorative lighting system of claim 4, wherein said nodes are addressed using an absolute reference scheme, so that nodes are addressed either individually or in series.

17. The decorative lighting system of claim 4, wherein said nodes are addressed using a relative reference scheme, so that nodes are addressed using a shift register.

18. The decorative lighting scheme of claim 1, wherein said control panel is configurable using one or more of a USB port, a web based interface, a personal computer, and a personal digital assistant.

19. The decorative lighting system of claim 4, further comprising a wireless interface used to control a plurality of nodes in series.

20. The decorative lighting system of claim 1, further comprising a wireless interface used to control a plurality of control panels in series.
